(19) United States
(12) Patent Application Publication
(10) Pub. No.: US 2024/0080743 A1
(43) Pub. Date: Mar. 7, 2024

(54) Conditional Handover Candidate Cell Selection

(71) Applicant: Apple Inc., Cupertino, CA (US)

(72) Inventors: ChunLei Lin, Hong Kong (HK); Alosious Pradeep Prabhakar, Singapore (SG); Vijay Venkataraman, San Jose, CA (US)

(21) Appl. No.: 18/460,351

(22) Filed: Sep. 1, 2023

Related U.S. Application Data
(60) Provisional application No. 63/404,446, filed on Sep. 7, 2022.

(51) Int. Cl. H04W 36/36; H04W 36/30

(52) U.S. Cl. CPC H04W 36/362; H04W 36/30; H04W 88/06

(57) ABSTRACT

This disclosure relates to techniques for performing conditional handover candidate cell selection in a wireless communication system. A wireless device and a cellular base station may establish a wireless link. The wireless device may receive conditional handover configuration information. The conditional handover configuration information may indicate one or more conditions for performing handover and cell candidates for the conditional handover. The wireless device may determine that multiple cell candidates meet the conditions for performing handover. A cell candidate to which to perform handover may be selected based at least in part on one or more wireless device conditions. The wireless device may perform handover to the selected cell candidate.

### PRIORITY INFORMATION

This application claims priority to U.S. provisional patent application Ser. No. 63/404,446, entitled “Conditional Handover Candidate Cell Selection,” filed Sep. 7, 2022, which is hereby incorporated by reference in its entirety as though fully and completely set forth herein.

### FIELD

The present application relates to wireless communications, and more particularly to systems, apparatuses, and methods for performing conditional handover candidate cell selection in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for performing conditional handover candidate cell selection in a wireless communication system.

According to the techniques described herein, it may be possible for a wireless device to evaluate which of various possible conditions are present for the wireless device that may affect the set of possible cell characteristics that are most relevant to the wireless device performance, user experience, and/or other metrics. When conditional handover is triggered with multiple candidate cells meeting the conditions for the handover, the wireless device may evaluate and prioritize those cells based on the cell characteristics corresponding to the set of wireless device conditions that are currently applicable. Based on such prioritization, the wireless device may be able to select a cell to which to perform the handover that may be expected to perform best for the specific circumstances of the wireless device.

The possible wireless device conditions that can be identified as present or absent and used as a basis on which to perform conditional handover cell selection could include any of a variety of possible conditions. In some embodiments, such conditions could include a jitter reduction condition (e.g., for when jitter sensitive applications or services are active), a dual subscriber identity module dual standby condition (e.g., for when the wireless device is in dual subscriber identity module dual standby operation), a high speed condition (e.g., for when the wireless device is travelling at a high speed, which could be determined as a speed that is above a configured threshold and/or in any of various other possible ways), an uplink performance condition (e.g., for when uplink centric or uplink high reliability applications or services are active), among various other possible conditions.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for performing conditional handover candidate cell selection in a wireless communication system, according to some embodiments;

FIG. 6 is a communication flow diagram illustrating aspects of an exemplary possible conditional handover, according to some embodiments;

FIG. 7 is a communication timeline illustrating aspects of an example dual subscriber identity module dual standby communication scenario for a wireless device, according to some embodiments;

FIG. 8 is a table illustrating various possible dual subscriber identity module dual standby radio frequency band combinations for candidate cells for a conditional handover in an example scenario, according to some embodiments;

FIG. 9 illustrates comparative aspects of an example scenario in which a source stream could be provided via a frequency division duplexing cell or a time division duplexing cell, according to some embodiments;

FIG. 10 illustrates aspects of an example scenario in which a wireless device on a high speed train can select from four candidate cells for a conditional handover, according to some embodiments;

FIG. 11 illustrates aspects of an example scenario in which a wireless device can select from a candidate cell with supplementary uplink available or a candidate cell without supplementary uplink available, according to some embodiments;

FIG. 12 is a flowchart diagram illustrating exemplary aspects of a possible method for performing conditional handover based at least in part on wireless device side considerations, according to some embodiments;

FIG. 13 is a table illustrating examples of possible priority weighting values that could be applied to the priority values output for various possible wireless device conditions, according to some embodiments;

FIG. 14 illustrates example aspects of one possible technique for performing minimum jitter conditional handover candidate selection, according to some embodiments;

FIG. 15 is a table illustrating one possible set of priority values that could be output according to the method of FIG. 14 for an example set of conditional handover candidate cells, according to some embodiments;

FIG. 16 illustrates example aspects of one possible technique for performing dual subscriber identity module dual standby radio frequency combination conditional handover candidate selection, according to some embodiments;

FIG. 17 is a table illustrating one possible set of priority values that could be output according to the method of FIG. 16 for an example set of conditional handover candidate cells, according to some embodiments;

FIG. 18 illustrates example aspects of one possible technique for performing high speed conditional handover candidate selection, according to some embodiments;

FIG. 19 is a table illustrating one possible set of priority values that could be output according to the method of FIG. 18 for an example set of conditional handover candidate cells, according to some embodiments;

FIG. 20 illustrates example aspects of one possible technique for performing uplink performance conditional handover candidate selection, according to some embodiments; and

FIG. 21 is a table illustrating one possible set of priority values that could be output according to the method of FIG. 20 for an example set of conditional handover candidate cells, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point
DCI: Downlink Control Information
CORESET: Control Resource Set
QCL: Quasi-Co-Located or Quasi-Co-Location
CSI: Channel State Information
CSI-RS: Channel State Information Reference Signals
CSI-IM: Channel State Information Interference Management
CMR: Channel Measurement Resource
IMR: Interference Measurement Resource
ZP: Zero Power
NZP: Non Zero Power
CQI: Channel Quality Indicator
PMI: Precoding Matrix Indicator
RI: Rank Indicator

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

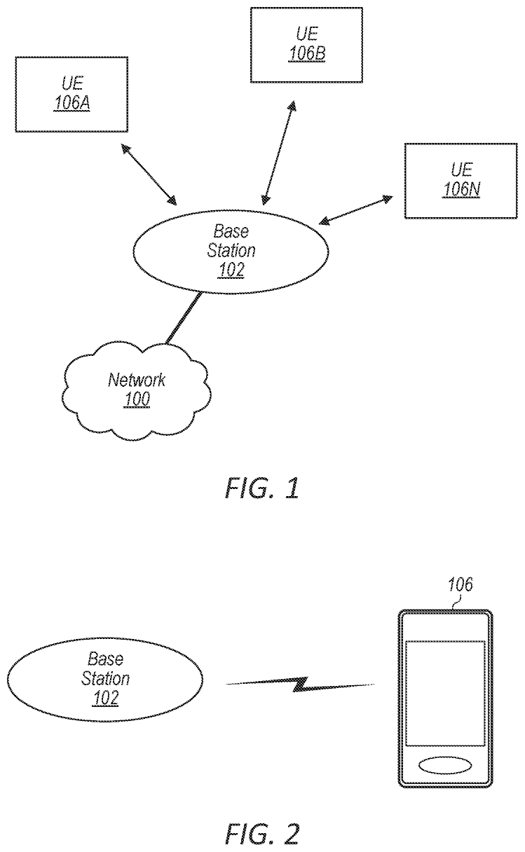

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP NR contexts, base station (gNB) functionality can be split between a centralized unit (CU) and a distributed unit (DU). The illustrated base station 102 may support the functionality of either or both of a CU or a DU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for conditional handover candidate cell selection in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM, etc.), and separate radios for communicating using each of Wi-Fi and BLUETOOTH™. Other configurations are also possible.

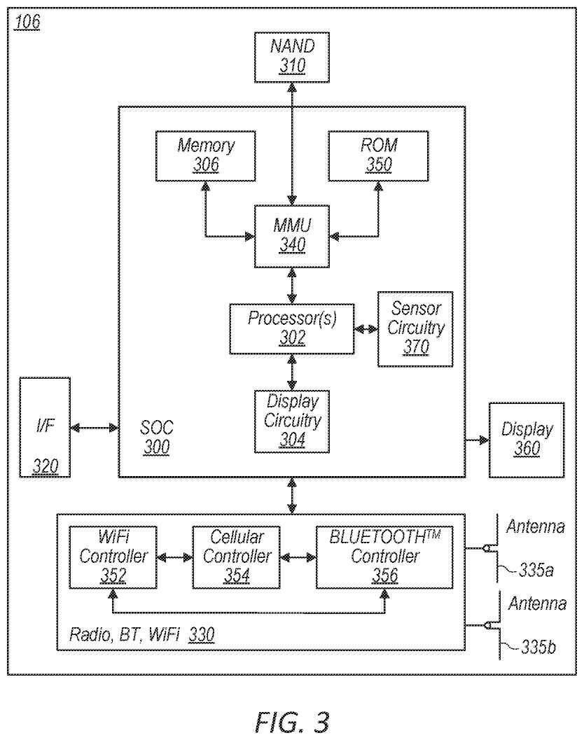

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector OF 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for conditional handover candidate cell selection in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for conditional handover candidate cell selection in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

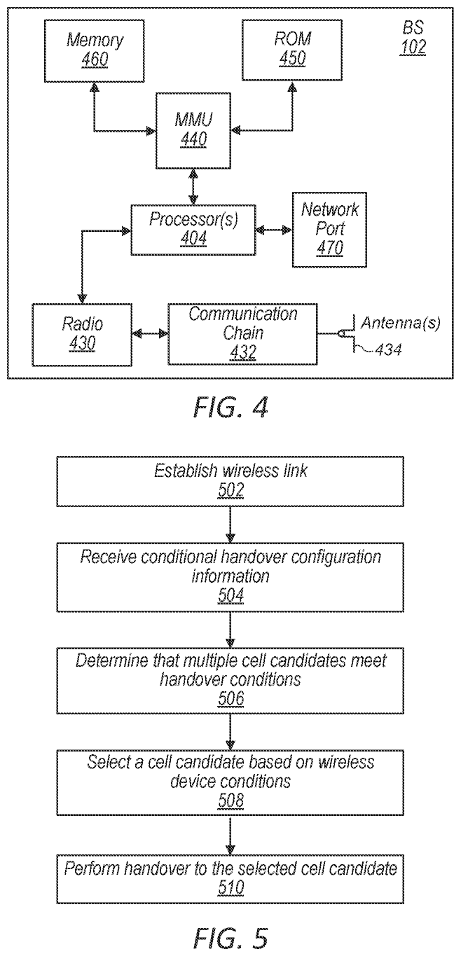

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### FIG. 5—Conditional Handover Candidate Cell Selection

Handover between cells in a cellular communication may be performed in multiple possible ways. As one possibility, a “conventional” or “legacy” handover may include a handover in which a serving cell initiates and selects a target cell for the handover based on in-time serving and/or neighbor cell measurement reporting from a wireless device, at least according to some embodiments. As another possibility, a “conditional handover” (CHO) may include a handover that is executed by a wireless device when one or more handover execution conditions (which may be pre-configured for the wireless device by its serving cell) are met, at least according to some embodiments. For example, the wireless device may start evaluating the execution condition(s) upon receiving CHO configuration information from its serving cell, and may stop evaluating the execution condition(s) once a handover is executed, at least according to some embodiments.

In some instances, it may be possible that multiple cells meet the configured CHO execution condition(s), such that handover could be performed to any of those multiple cells. Accordingly, it may be useful to provide techniques for selecting to which candidate cell to perform handover in such a scenario, at least according to some embodiments. To illustrate one such set of possible techniques, FIG. 5 is a flowchart diagram illustrating a method for performing conditional handover candidate cell selection, at least according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, the wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons. In some instances, the handover(s) can include conditional handover(s), potentially in which there are multiple candidate cells that meet the conditional handover execution condition(s), as described further herein.

At least in some instances, establishing the wireless link(s) may include the wireless device providing capability information for the wireless device. Such capability information may include information relating to any of a variety of types of wireless device capabilities.

In 504, the wireless device may receive conditional handover configuration information. The CHO configuration information may indicate one or more conditions for performing handover and one or more cell candidates for the CHO. In some instances, there may be multiple cell candidates. The wireless device may evaluate the CHO execution conditions, which may include one or more cell signal strength and/or cell signal quality related conditions (e.g., serving cell signal strength and/or quality falling below a configured threshold, neighbor cell signal strength and/or quality being better than serving cell signal strength and/or quality be more than a configured threshold, etc.), one or more time related conditions (e.g., entering a configured time window prior to a cell stopping serving its current service area), one or more location related conditions (e.g., entering a cell-edge location), and/or any of a variety of other possible execution conditions.

In 506, the wireless device may determine that multiple cell candidates meet the configured conditional handover execution condition(s). At least according to some embodiments (e.g., in at least some 3GPP based communication systems), the wireless device may have discretion to select which of the multiple cell candidates that meet the condition(s) for performing handover to which to perform handover.

In 508, the wireless device may select a cell candidate from the multiple cell candidates that meet the condition(s) for performing handover. The cell candidate may be selected based at least in part on one more conditions at the wireless device. For example, the cell candidates may be prioritized based on certain of their cell characteristics, where the cell characteristics that factor into the prioritization are determined based on which wireless device condition(s) (e.g., of multiple possible wireless device conditions) are applicable for the handover.

As one such possible wireless device condition, the wireless device may determine if the wireless device has any jitter sensitive applications or services active. If such a jitter sensitive application or service based condition is present, the wireless device may evaluate the cell candidates and perform candidate cell selection based at least in part on one or more cell characteristics that may affect how much jitter the wireless device is likely to experience during communication with each candidate cell. For example, candidate cell duplexing configuration (e.g., whether a cell is configured for time division duplexing (TDD) or frequency division duplexing (FDD)) may be considered in such a scenario, e.g., since TDD cells may experience more jitter on average than FDD cells, at least in some instances. Cell slot duration may also or alternatively be considered when a jitter sensitive application or service based condition is present, according to some embodiments, for example since cells with longer slot duration may experience more jitter on average than cells with shorter slot duration, at least in some instances. For TDD cells, cell downlink uplink transmission periodicities (e.g., how often the TDD cell switches between downlink slots and uplink slots) may also or alternatively be considered in such a scenario, for example since cells with longer downlink uplink transmission periodicities may experience more jitter on average than cells with shorter downlink uplink transmission periodicities, at least in some instances. Thus, at least in some instances, when a jitter minimization condition is present, FDD cells may be prioritized over TDD cells, cells with shorter slot duration may be prioritized over cells with longer slot duration, and/or cells with lower cell downlink uplink transmission periodicity may be prioritized over cells with higher cell downlink uplink transmission periodicity.

As another possible wireless device condition, the wireless device may determine if the wireless device is a multi-subscriber identity module (SIM) device with dual SIM dual standby (DSDS) operation active. If such a DSDS based condition is present, the wireless device may evaluate the cell candidates and perform candidate cell selection based at least in part on one or more cell characteristics that may affect DSDS operation. For example, it may be possible that certain frequency band combinations that could result from DSDS operation with one or more candidate cells and the serving cell of the other SIM of the wireless device could be unsupported or otherwise less preferable for the wireless device (e.g., due to the antenna design of the wireless device and/or for any of various other reasons). In such a scenario, it may be the case that candidate cell frequency band combination may be considered when DSDS is active for the wireless device. In some instances, the wireless device may more particularly determine a frequency combination for DSDS operation for each of the cell candidates that meet the condition(s) for performing handover, and may prioritize cells for which wireless device supports the resulting frequency combination over cells for which the wireless device does not support the resulting frequency combination, when a DSDS active condition is present.

As a further possible wireless device condition, the wireless device may determine if the wireless device is travelling at a high speed. Determining whether the wireless device is considered to be at high speed could be performed in any of a variety of ways (e.g., using motion sensing circuitry of the wireless device, frequency of recent handovers, global navigational satellite system based location information, and/or any of various other possible techniques), according to various embodiments. If such a speed based condition is present, the wireless device may evaluate the cell candidates and perform candidate cell selection based at least in part on one or more cell characteristics that may provide better wireless device performance in high speed conditions. For example, certain operating frequencies (e.g., lower frequencies) may tend to have lower path loss than other operating frequencies (e.g., higher frequencies), which may lead to differences in cell coverage range. For wireless devices experiencing mobility, cells with larger coverage ranges may reduce handover frequency, which may be particularly beneficial for high mobility wireless devices (e.g., those moving at high speeds), at least according to some embodiments. Thus, in such a scenario, it may be the case that candidate cell frequency may be considered when the wireless device is travelling at a high speed; for example, cells with lower operating frequencies and/or operating in lower frequency ranges may be prioritized over cells with higher operating frequencies when a high wireless device speed condition is present, as one possibility.

As yet another possible wireless device condition, the wireless device may determine if the wireless device has any uplink centric or uplink high reliability applications or services active. If such an uplink performance based condition is present, the wireless device may evaluate the cell candidates and perform candidate cell selection based at least in part on one or more cell characteristics that may affect the uplink communication capability and/or reliability for each candidate cell. For example, cell supplementary uplink configuration (e.g., whether supplementary uplink is configured) for each candidate cell that meets the condition(s) for performing handover may be considered in such a scenario, e.g., since cells with supplementary uplink configured may provide better uplink reliability and/or other communication characteristics than cells without supplementary uplink configured, at least in some instances. Thus, at least in some instances, when an uplink performance based condition is present, candidate cells with supplementary uplink configured may be prioritized over candidate cells without supplementary uplink configured.

In some instances, it may be possible that multiple of the wireless device conditions described herein and/or other wireless device conditions could be applicable to the same conditional handover candidate cell selection. In such a scenario, it may be possible to combine cell priorities associated with each individual wireless device condition to determine an overall cell priority for each of the candidate cells that meets the condition(s) for performing handover, and to select the cell candidate with the best overall cell priority as the cell candidate to which to perform handover. For example, in some instances, it may be possible to determine cell priority values for each of the cell candidates that meet the one or more conditions for performing handover for each of the one or more wireless device conditions. The cell priority values may be determined based at least in part on cell characteristics for the cell candidates that meet the one or more conditions for performing handover, e.g., such as according to the techniques described herein (and/or according to variations on or alternatives thereto). The cell priority values for each of the one or more wireless device conditions may be combined for a given candidate cell to calculate the overall cell priority for that cell by adding them together, multiplying them, averaging them, and/or in any of various other possible ways.

In some instances, the cell priority values may be weighted, e.g., based on the relative priority of the one or more wireless device conditions. For example, the weighting for the cell priority value for reducing jitter could be greater than the weighting for the cell priority value for DSDS, which could in turn be greater than the weighting for the cell priority value for high speed, which could in turn be greater than the weighting for the cell priority value for uplink performance, as one possibility. Other relative priorities are also possible. If such weighting is used, it may be the case that the weighted cell priority values for each of the one or more wireless device conditions are combined for a given candidate cell to calculate the overall cell priority for that cell.

Note that in scenarios in which not all of the possible wireless device conditions according to which the wireless device is capable of evaluating and prioritizing cell candidates are applicable, it may be the case that the wireless device does not evaluate and prioritize the available cell candidates according to those wireless device conditions that are not applicable. Alternatively, it may be possible that the wireless device does evaluate and prioritize cell candidates for all possible wireless device conditions according to which the wireless device is capable of evaluating and prioritizing cell candidates, but applies a weighting of 0 to any priority values associated with wireless device conditions that are not applicable for a given conditional handover. In either approach, it may be the case that the candidate cell selection for a conditional handover is effectively based on cell characteristics for the candidate cells that are relevant to the applicable conditions of the wireless device for the conditional handover, at least according to some embodiments.

In 510, the wireless device may perform handover to the selected cell candidate. At least according to some embodiments, this may include performing a random access channel (RACH) procedure with the selected cell candidate and conclude with providing a RRC reconfiguration complete message to the selected cell candidate, after which the selected cell candidate may be the new serving cell for the wireless device.

Thus, at least according to some embodiments, the method of FIG. 5 may be used to provide a framework according to which a wireless device can perform cell selection for a conditional handover in a manner that takes the current circumstances of the wireless device into account, and which may facilitate selection of a cell that can provide better performance for the wireless device in view of those circumstances, at least in some instances.

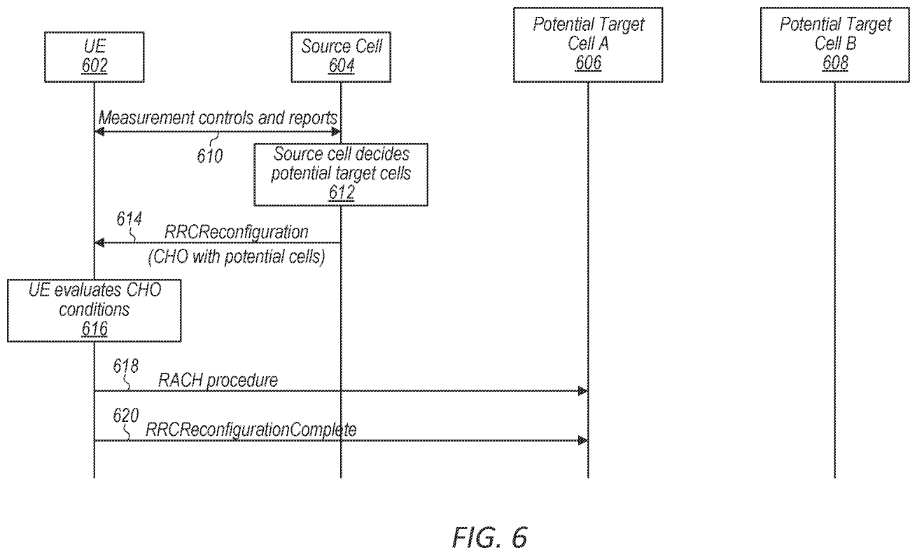

### FIGS. 6-21 and Additional Information

FIGS. 6-21 illustrate further aspects that might be used in conjunction with the method of FIG. 5 if desired. It should be noted, however, that the exemplary details illustrated in and described with respect to FIGS. 6-21 are not intended to be limiting to the disclosure as a whole: numerous variations and alternatives to the details provided herein below are possible and should be considered within the scope of the disclosure.

A conditional handover (CHO) may include a handover that is executed by a UE when one or more handover execution conditions are met. The UE may start evaluating the execution condition(s) upon receiving CHO configuration information from its serving cell, and may stop evaluating the execution condition(s) once a handover is executed, at least according to some embodiments.

FIG. 6 is a communication flow diagram illustrating aspects of an exemplary possible conditional handover, according to some embodiments. As shown, the illustrated communication flow may be performed between a UE 602, a source cell 604, a potential target cell “A” 606, and a potential target cell “B” 608. In 610, the UE 602 may perform measurement and reporting under the control of the source cell 604. In 612, the source cell 604 may select potential target cells for a conditional handover, which may include potential target cell “A” 606 and potential target cell “B” 608. In 614, the source cell 604 may provide RRC reconfiguration information to the UE 602 to configure CHO with the selected potential cells. In 616, the UE may evaluate the configured CHO execution condition(s). When the condition(s) is (are) met, in 618, the UE 602 may perform a RACH procedure with a cell that meets the condition(s) (e.g., potential target cell “A”, in the illustrated scenario). In 620, the UE may provide a RRC reconfiguration complete message to the target cell to complete the conditional handover. Note that it may be the case that if multiple cells (e.g., multiple NR cells) are triggered in conditional handover execution, it may be left to UE implementation to determine which of those cells to select.

It may be possible to arbitrarily or randomly select a cell when multiple potential target cells meet the condition(s) for a conditional handover, as one possibility. Alternatively, any of a variety of possible considerations or criteria may be used to assist with or otherwise drive the selection process. There may be many possible reasons to select one cell over another, potentially including reasons based on cell characteristics for the potential target cells and/or reasons based on device characteristics for the UE making the selection, among various possibilities.

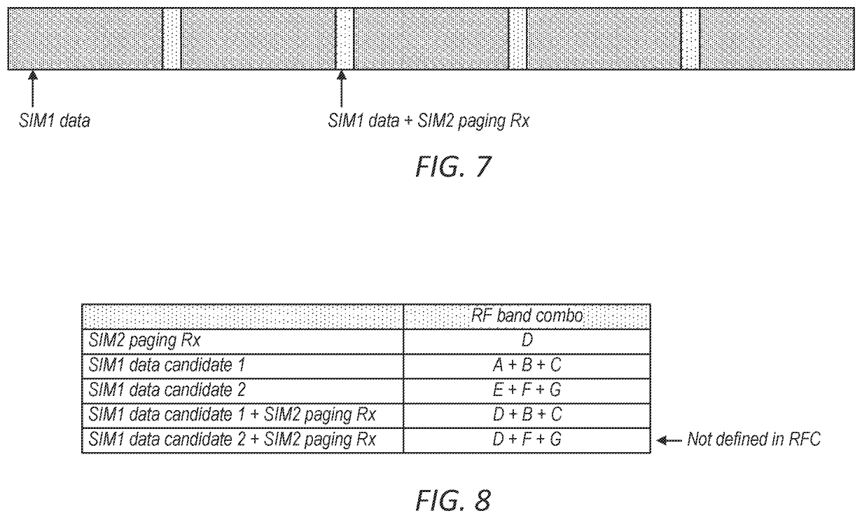

As one possible consideration, for example for a dual subscriber identity module (SIM) dual standby (DSDS), the UE may consider which RF band combinations would be used for different candidate cells. For a DSDS device, when the SIM1 is in connected state with uplink/downlink data communication ongoing, the RF may also tune to the SIM2 serving band to monitor paging during the SIM2 paging occasions. For example, as illustrated in FIG. 7, for such a device, there may be occasions on which SIM1 data communication only is being performed, as well as occasions on which both SIM1 data communication and SIM2 paging reception is being performed. The UE RF for such a device may work on different band combinations during SIM1 data and SIM1 data+SIM2 paging RX periods. For example, FIG. 8 is a table illustrating the various band combinations that could be used at different times and for different candidate cells in an example scenario. It may commonly be the case that a RF configuration (RFC) file maintained by the UE indicates which band combinations are supported (e.g., such that the antenna design has been tuned to optimize for the RX/TX performance for all the bands in the combination). However, if the band combinations during SIM2 paging RX periods are not defined in the RFC, there might be some degradation in the RF performance, which could cause missed paging in the SIM2 operation. Thus, in the example illustrated in FIG. 8, in which SIM1 data candidate 2+SIM2 paging RX leads to a RF band combination that is not defined in the UE RFC, it could be the case that candidate 1 (e.g., for which SIM1 data+SIM2 paging RX leads to a RF band combination that is defined in the UE RFC) is be a better choice (e.g., at least for DSDS purposes) if both candidates meet the condition(s) for a conditional handover.

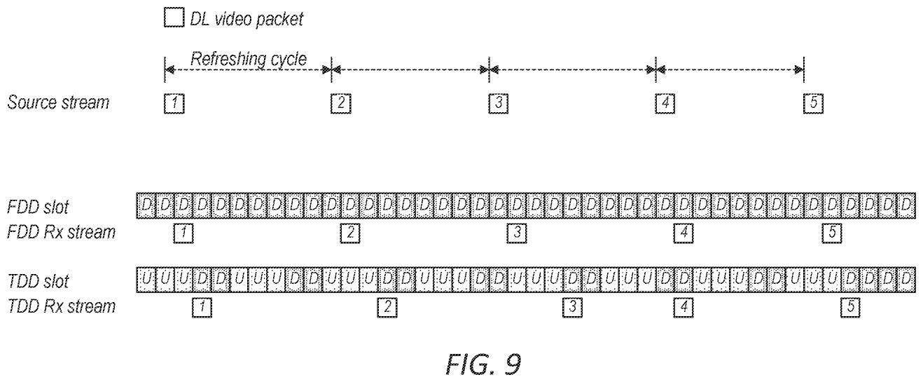

As another possible consideration, for example for a UE with a jitter-sensitive service active, the UE may consider the duplexing configurations for different candidate cells. Jitter-sensitive services could include extended reality (XR) service (e.g., augmented reality (AR)/virtual reality (VR)), for which video/audio packets may particularly benefit from steady delivery for smooth rendering, V2X service, for which minimal jitter may be important for vehicle status and control packets, and/or other any of a variety of other possible services. For time division duplexing (TDD) cells, it may be the case that since the uplink and downlink data and their retransmissions can only occur on predefined TX/RX slots, jitter may generally be higher than for frequency division duplexing (FDD) cells on which it may be possible to perform uplink and downlink data transmissions and retransmissions in any given slot. FIG. 9 illustrates comparative aspects of an example scenario in which a source stream could be provided via a FDD cell or a TDD cell. As shown, in the illustrated scenario, there may be more jitter for the TDD cell than for the FDD cell. Accordingly, it may be the case that FDD cells may be better than TDD cells (e.g., at least for jitter-sensitive service purposes) if both an FDD and a TDD cell meet the condition(s) for a conditional handover. Note that it may be further possible to prioritize different TDD cells differently, e.g., depending on their numerology, slot duration, and/or duplexing pattern (e.g., downlink-uplink transmission periodicity), for example since the jitter impact of a TDD cell may be lessened for TDD cells with shorter slot duration and/or with shorter downlink-uplink transmission periodicity.

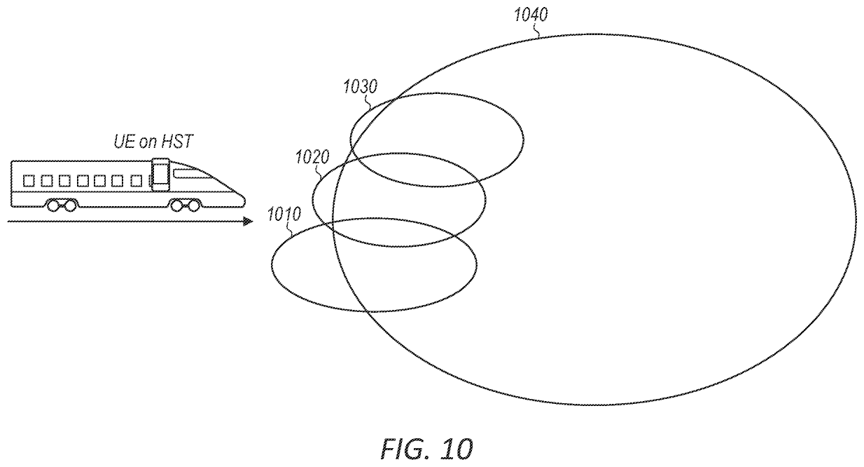

As a further possible consideration, for example for a UE travelling at a high speed, the UE may consider the frequencies for different candidate cells. At least in some instances, cells with higher frequencies (e.g., including those in 3GPP frequency range 2 (FR2) may have smaller coverage range (e.g., due to higher path loss). For UE mobility in high speed conditions, it may accordingly be preferable to choose lower frequency cells (e.g., cells in lower frequency bands, such as 3GPP frequency range 1 (FR1), and/or cells with lower frequency within the same frequency band), e.g., to avoid frequent handover. FIG. 10 illustrates aspects of an example scenario in which a UE on a high speed train (HST) can select from four candidate cells for a conditional handover, where cells 1010, 1020, 1030 are FR2 cells and cell 1040 is a FR1 cell. Thus, in the illustrated example, the FR1 cell 1040 may be better than the FR2 cells 1010, 1020, 1030 (e.g., at least for high speed mobility purposes) for a UE performing conditional handover.

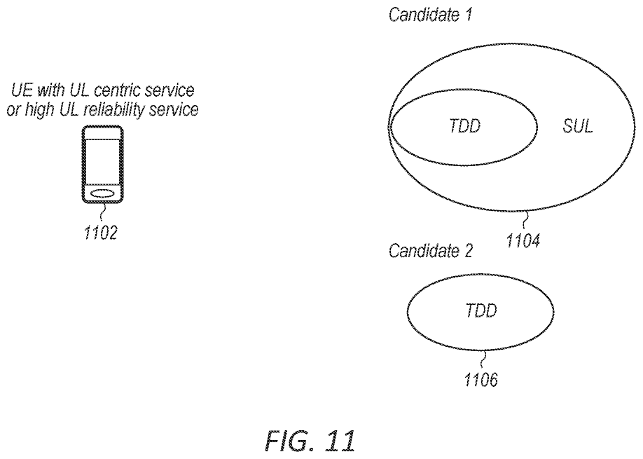

As yet another possible consideration, for example for a UE with uplink centric service and/or uplink high reliability service ongoing, the UE may consider whether different candidate cells have supplementary uplink (SUL) service available. In many instances, when CHO is triggered, a UE may be located in the cell edge area. Accordingly, if uplink centric or uplink high reliability service is ongoing, it may be preferable for the UE to choose a candidate cell with SUL available, e.g., for better uplink user experience. FIG. 11 illustrates aspects of an example scenario in which a UE 1102 with uplink centric service or high uplink reliability service active can select from a candidate cell 1104 with SUL available or a candidate cell 1106 without SUL available. In the illustrated example, the candidate cell 1104 with SUL available may be better than the candidate cell 1106 without SUL available (e.g., at least for uplink centric service and/or uplink high reliability service purposes) for the UE 1102 performing conditional handover.

It may be possible to use multiple of these considerations (and/or other considerations) when performing candidate cell selection for conditional handover, at least according to some embodiments. For example, it may be possible to rank or otherwise prioritize candidate cells for each of multiple possible purposes, with those rankings/priorities potentially further being weighted according to the relative priority/importance of the different purposes, and for the resulting (potentially weighted) rankings/priorities to be summed, averaged, or otherwise combined to determine the best cell for a UE to select among multiple candidate cells given the current circumstances of the UE.

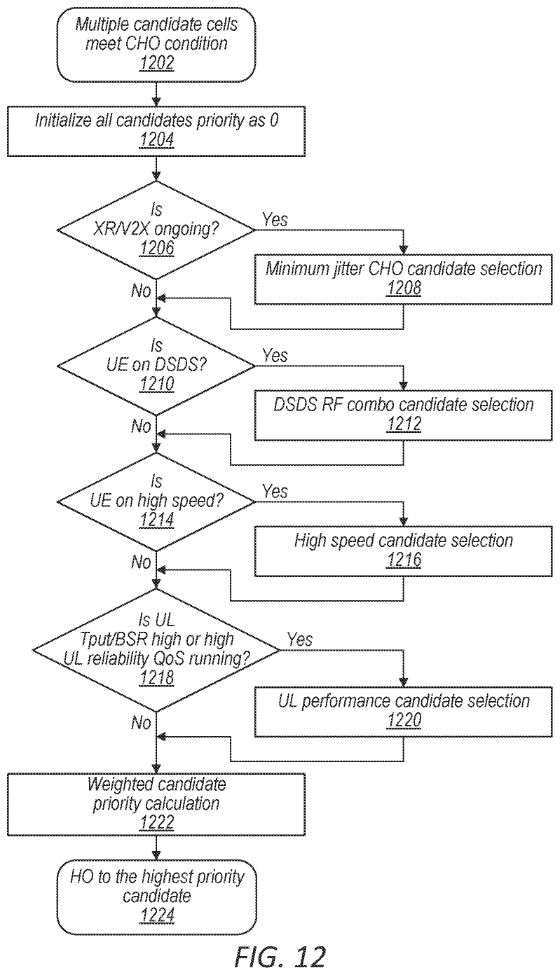

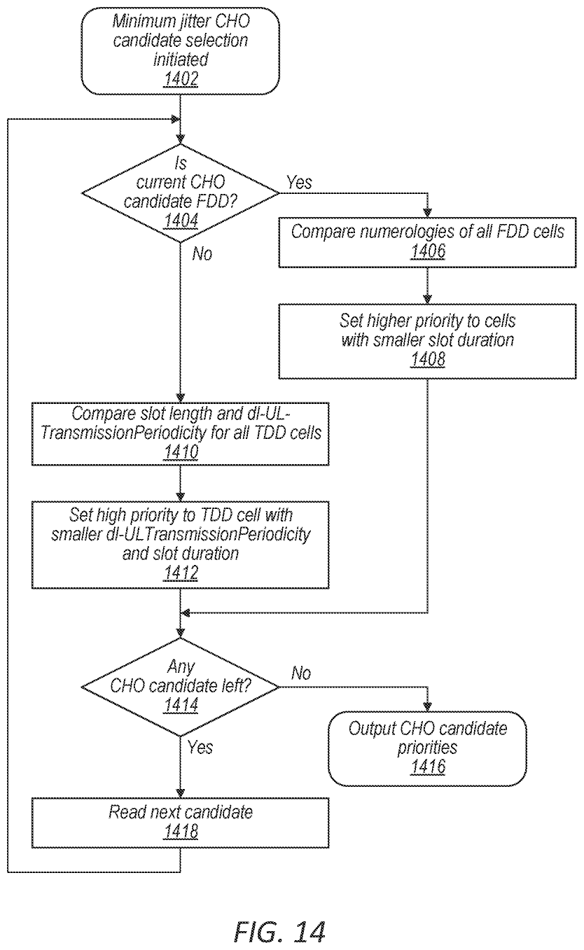

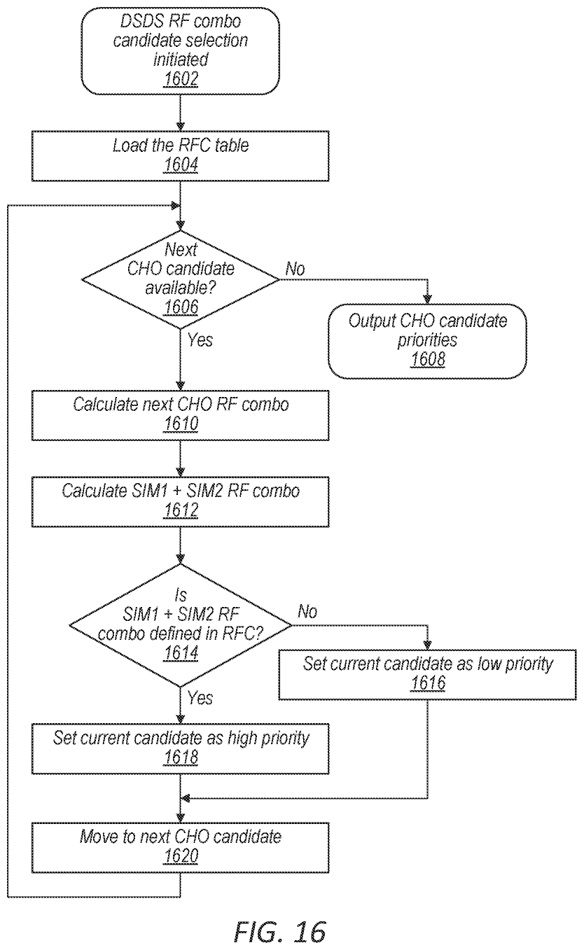

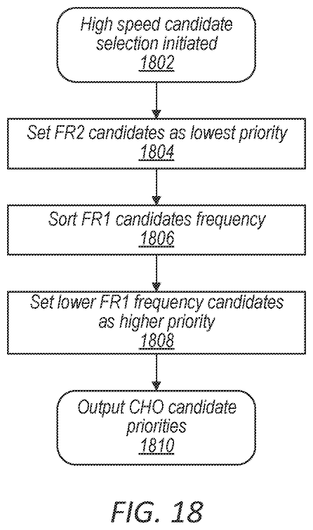

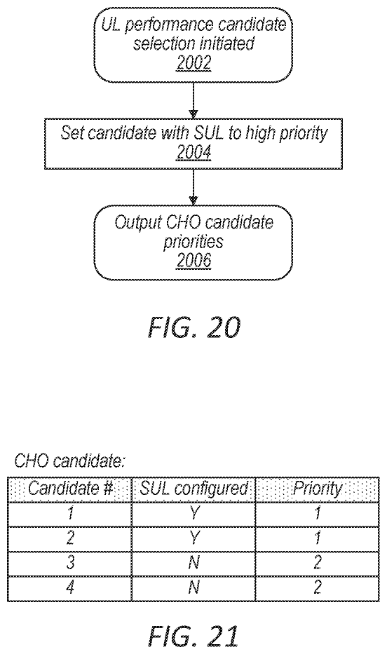

FIG. 12 is a flowchart diagram illustrating exemplary aspects of one such possible method for performing conditional handover based at least in part on UE side considerations. As shown, in 1202, a UE may determine that multiple candidate cells meet the conditional handover execution condition(s) configured for the UE. In 1204, the UE may initiate all candidates' priority as 0. In 1206, the UE may determine whether any XR and/or V2X services are ongoing. If yes, in 1208, the UE may perform minimum jitter conditional handover candidate selection. Such selection may be performed in accordance with the method of FIG. 14, as one possibility, or in any of various other ways, according to various embodiments. After minimum jitter conditional handover candidate selection, or after determining that no XR or V2X services are ongoing, in 1210, the UE may determine if it is on DSDS mode. If yes, in 1212, the UE may perform DSDS RF combination candidate selection. Such selection may be performed in accordance with the method of FIG. 16, as one possibility, or in any of various other ways, according to various embodiments. After DSDS RF combination candidate selection, or after determining that the UE is not on DSDS mode, in 1214, the UE may determine if it is on high speed mode. If yes, in 1216, the UE may perform high speed candidate selection. Such selection may be performed in accordance with the method of FIG. 18, as one possibility, or in any of various other ways, according to various embodiments. After high speed candidate selection, or after determining that the UE is not on high speed mode, in 1218, the UE may determine if uplink throughput/buffer status report is high or high uplink reliability Quality of Service (QoS) is running. If yes, in 1220, the UE may perform UL performance candidate selection. Such selection may be performed in accordance with the method of FIG. 20, as one possibility, or in any of various other ways, according to various embodiments. After UL performance candidate selection, or after determining that the UE does not need to perform UL performance candidate selection, in 1222, the UE may perform weighted candidate priority calculation.

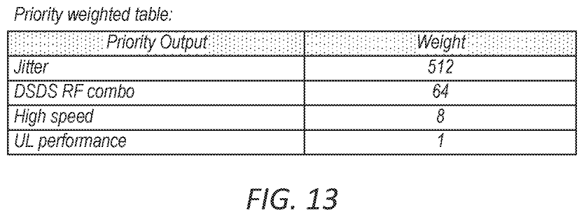

The weighted candidate priority calculation may include multiplying the priority values output by the applicable conditional handover candidate selection processes by weight values selected according to the relative importance of those considerations to the UE. As one example, a priority weighted table such as illustrated in FIG. 13 may be used. In the illustrated example, the jitter priority output may have a weight of 512, the DSDS RF combination priority output may have a weight of 64, the high speed priority output may have a weight of 8, and the UL performance priority output may have a weight of 1, such that the final priority for a given cell for which all of these considerations are applicable may be calculated as 512*jitter priority+64*DSDS RF combination priority+8*high speed priority+1*UL performance priority. Note that if one or more potential UE considerations are not applicable, cell priority values for that consideration may be set to 0 for all candidate cells (at least as one option), which may result in that consideration not being included in the weighted candidate priority selection, at least according to some embodiments. In 1224, handover may be performed to the highest priority candidate according to the weighted candidate priority calculation. Note that the highest priority candidate may be the candidate cell with the lowest weighted candidate priority value (e.g., the value closest to 1), at least according to some embodiments.

As previously noted herein, FIG. 14 illustrates example aspects of one possible technique for performing minimum jitter conditional handover candidate selection, according to some embodiments. As shown, in 1402, a UE may determine that minimum jitter CHO candidate selection is initiated (e.g., if step 1208 of FIG. 12 is triggered). In 1404, the UE may determine if the current CHO candidate is a FDD cell. If yes, in 1406, the UE may compare numerologies of all FDD candidate cells, and in 1408, the UE may set higher priority (e.g., a lower priority value) among FDD cells to cells with smaller slot durations. If the current CHO candidate is not a FDD cell, in 1410, the UE may compare slot length and downlink-uplink transmission periodicity for all TDD cells, and in 1412, the UE may set higher priority among TDD cells to cells with lower downlink-uplink transmission periodicity and slot duration. After selecting a priority value for the cell (regardless of whether the cell is a FDD cell or a TDD cell), in 1414, the UE may determine if there are any CHO candidates left that have not yet had minimum jitter priority selection performed. If so, in 1418, the UE may return to step 1404 and repeat the method for the next cell. Once all CHO candidates have been assigned a priority value for minimum jitter conditional handover candidate selection, in 1416, the minimum jitter conditional handover candidate priority values may be output.

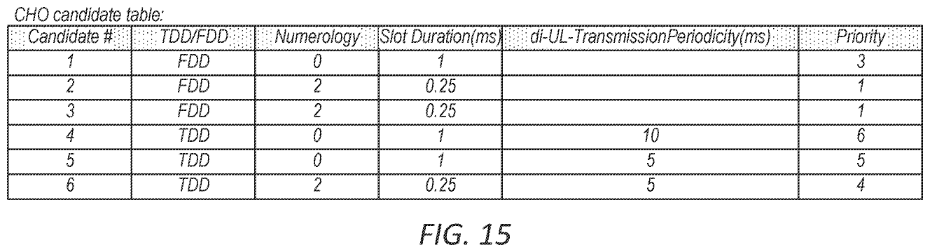

FIG. 15 is a table illustrating one possible set of priority values that could be output according to the method of FIG. 14 for an example set of CHO candidate cells. As shown, for FDD cell candidates #1, #2, and #3, candidate cells #2 and #3 have the lower slot duration, and so are assigned a priority value of 1. The remaining FDD candidate #1 may be assigned a priority value of 3. Among the TDD cell candidates #4, #5, and #6, candidate #6 has the lower slot duration and downlink-uplink transmission periodicity, and may be assigned a priority value of 4. Candidates #4 and #5 have the same slot duration, but candidate #5 has the lower downlink-uplink transmission periodicity among candidates #4 and #5, so candidate #5 may be assigned a priority value of 5 while candidate #4 may be assigned a priority value of 6.

FIG. 16 illustrates example aspects of one possible technique for performing DSDS RF combination conditional handover candidate selection, according to some embodiments. As shown, in 1602, a UE may determine that DSDS RF combination CHO candidate selection is initiated (e.g., if step 1212 of FIG. 12 is triggered). In 1604, the UE may load the RFC table for the UE. In 1606, the UE may determine if there are any CHO candidates left that have not yet had DSDS RF combination priority selection performed. If so, in 1610, the UE may calculate the next CHO candidate cell RF combination. In 1612, the UE may calculate the RF combination for SIM1+SIM2 operation for the UE. In 1614, the UE may determine if the SIM1+SIM2 RF combination is defined in the RFC for the UE. If not, in 1616, the current candidate cell may be set as low DSDS RF combination priority (e.g., with a priority value of 2). If the SIM1+SIM2 RF combination is defined in the RFC for the UE, in 1618, the current candidate cell may be set as high DSDS RF combination priority (e.g., with a priority value of 1). In 1620, the UE may proceed to the next CHO candidate, returning to step 1606. If there are no further CHO candidates available, in 1608, the DSDS RF combination conditional handover candidate priority values may be output.

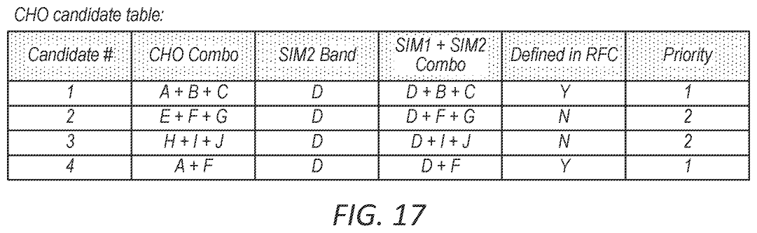

FIG. 17 is a table illustrating one possible set of priority values that could be output according to the method of FIG. 16 for an example set of CHO candidate cells. As shown, for cell candidates #1 and #4, the SIM1+SIM2 frequency combination is defined in RFC, and so these cells are assigned a priority value of 1. For the remaining cell candidates #2 and #3, the SIM1+SIM2 frequency combination is not defined in RFC, and so these cells are assigned a priority value of 2.

FIG. 18 illustrates example aspects of one possible technique for performing high speed conditional handover candidate selection, according to some embodiments. As shown, in 1802, a UE may determine that high speed CHO candidate selection is initiated (e.g., if step 1216 of FIG. 12 is triggered). In 1804, the UE may set FR2 candidate cells as lowest priority. In 1806, any FR1 candidates may be sorted by frequency. In 1808, lower frequency FR1 cell candidates may be set as having higher priority. In 1810, the high speed conditional handover candidate priority values may be output.

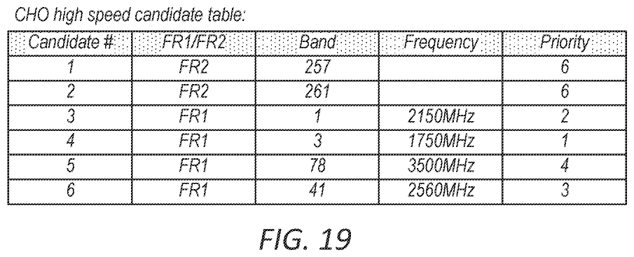

FIG. 19 is a table illustrating one possible set of priority values that could be output according to the method of FIG. 18 for an example set of CHO candidate cells. As shown, cell candidates #1 and #2 may be in FR2, and so these cells may be assigned the priority value of 6 (e.g., may have the lowest priority). For the cell candidates #3, #4, #5, and #6, which are all in FR1, the lowest frequency candidate cell #4 may be assigned a priority value of 1, the next lowest frequency candidate cell #3 may be assigned a priority value of 2, the next lowest frequency candidate cell #6 may be assigned a priority value of 3, and the next lowest frequency candidate cell #5 may be assigned a priority value of 4.

FIG. 20 illustrates example aspects of one possible technique for performing UL performance conditional handover candidate selection, according to some embodiments. As shown, in 2002, a UE may determine that UL performance CHO candidate selection is initiated (e.g., if step 1220 of FIG. 12 is triggered). In 2004, the UE may set candidate cells with SUL to high priority. In 2006, the UL performance conditional handover candidate priority values may be output.

FIG. 21 is a table illustrating one possible set of priority values that could be output according to the method of FIG. 20 for an example set of CHO candidate cells. As shown, cell candidates #1 and #2 may have SUL configured, and so these cells may be assigned the priority value of 1 (e.g., may have the highest priority). For the remaining cell candidates #3 and #4, SUL may not be configured, and so these cells are assigned a priority value of 2.

In the following further exemplary embodiments are provided.

One set of embodiments may include an apparatus, comprising: a processor configured to cause a wireless device to: establish a wireless link with a cellular base station; receive conditional handover configuration information, wherein the conditional handover configuration information indicates one or more conditions for performing handover and a plurality of cell candidates; determine that multiple cell candidates meet the one or more conditions for performing handover; select a cell candidate to which to perform handover based at least in part on one or more wireless device conditions; and perform handover to the selected cell candidate.

According to some embodiments, the one or more wireless device conditions include at least a jitter sensitive application or service based condition.

According to some embodiments, the cell candidate to which to perform handover is selected further based at least in part on one or more of cell candidate duplexing configurations, slot durations, or downlink uplink transmission periodicities for each of the multiple cell candidates that meet the one or more conditions for performing handover based at least in part on the one or more wireless device conditions including at least a jitter sensitive application or service based condition.

According to some embodiments, the one or more wireless device conditions include at least a dual subscriber identity module dual standby based condition.

According to some embodiments, the processor is further configured to cause the wireless device to: determine a frequency combination for dual subscriber identity module dual standby operation for each of the multiple cell candidates that meet the one or more conditions for performing handover, wherein the cell candidate to which to perform handover is selected further based at least in part on the frequency combinations for dual subscriber identity module dual standby operation for each of the multiple cell candidates that meet the one or more conditions for performing handover based at least in part on the one or more wireless device conditions including at least a dual subscriber identity module dual standby based condition.

According to some embodiments, the one or more wireless device conditions include at least a wireless device speed based condition.

According to some embodiments, the cell candidate to which to perform handover is selected further based at least in part on cell candidate operating frequencies for each of the multiple cell candidates that meet the one or more conditions for performing handover based at least in part on the one or more wireless device conditions including at least a wireless device speed based condition.

According to some embodiments, the one or more wireless device conditions include at least an uplink performance based condition.

According to some embodiments, the cell candidate to which to perform handover is selected further based at least in part on whether supplementary uplink is configured for each of the multiple cell candidates that meet the one or more conditions for performing handover based at least in part on the one or more wireless device conditions including at least an uplink performance based condition.

Another set of embodiments may include a wireless device, comprising: an antenna; a radio operably coupled to the antenna; and a processor operably coupled to the radio; wherein the wireless device is configured to: establish a wireless link with a cellular base station; receive conditional handover configuration information, wherein the conditional handover configuration information indicates one or more conditions for performing handover and a plurality of cell candidates; determine that multiple cell candidates meet the one or more conditions for performing handover; select a cell candidate to which to perform handover based at least in part on one or more wireless device conditions; and perform handover to the selected cell candidate.

According to some embodiments, to select a cell candidate to which to perform handover, the wireless device is further configured to: determine cell priority values for each of the cell candidates that meet the one or more conditions for performing handover for each of the one or more wireless device conditions, wherein the cell priority values are determined based at least in part on cell characteristics for the cell candidates that meet the one or more conditions for performing handover; weight the cell priority values based at least in part on relative priority of the one or more wireless device conditions; and determine an overall cell priority value for each of the plurality of cell candidates based at least in part on the weighted cell priority values, wherein a cell candidate with a best overall cell priority value is selected as the cell candidate to which to perform handover.

According to some embodiments, the overall cell priority value for each respective cell candidate of the plurality of cell candidates is determined by adding together the weighted cell priority values for the respective cell candidate for each of the one or more wireless device conditions.

According to some embodiments, the one or more wireless device conditions include whether one or more jitter sensitive applications or services are active for the wireless device.

According to some embodiments, the one or more wireless device conditions include whether the wireless device is operating in a dual subscriber identity module (SIM) dual standby mode.

According to some embodiments, the one or more wireless device conditions include whether the wireless device is operating in a high speed mode.

According to some embodiments, the one or more wireless device conditions include whether one or more uplink centric or uplink high reliability applications or services are active for the wireless device.

Yet another set of embodiments may include a method, comprising: by a wireless device: establishing a wireless link with a cellular base station; receiving conditional handover configuration information, wherein the conditional handover configuration information indicates one or more conditions for performing handover and a plurality of cell candidates; determining that multiple cell candidates meet the one or more conditions for performing handover; prioritizing the multiple cell candidates that meet the one or more conditions for performing handover, wherein the multiple cell candidates that meet the one or more conditions for performing handover are prioritized based at least in part on cell characteristics for the multiple cell candidates that meet the one or more conditions for performing handover, wherein the cell characteristics used to prioritize the multiple cell candidates that meet the one or more conditions for performing handover are selected based on one or more wireless device conditions; selecting a highest priority cell candidate among the multiple cell candidates that meet the one or more conditions for performing handover to which to perform handover; and performing handover to the selected cell candidate.

According to some embodiments, the method further comprises: determining which wireless device conditions of a plurality of possible wireless device conditions are applicable for the conditional handover.

According to some embodiments, the one or more wireless device conditions include one or more of: a jitter reduction based condition; a dual subscriber identity module dual standby based condition; a wireless device speed based condition; or an uplink performance based condition.

According to some embodiments, the cell characteristics include one or more of: cell duplexing configuration; cell slot duration; cell downlink uplink transmission periodicity; cell frequency; cell frequency band combination; or cell supplementary uplink configuration.

A further exemplary embodiment may include a method, comprising: performing, by a wireless device, any or all parts of the preceding examples.

Another exemplary embodiment may include a device, comprising: an antenna; a radio coupled to the antenna; and a processor operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processor configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus, comprising:
a processor configured to cause a wireless device to:
receive conditional handover configuration information from a cellular base station, wherein the conditional handover configuration information indicates one or more conditions for performing handover and a plurality of cell candidates;
determine that multiple cell candidates meet the one or more conditions for performing handover;
select a cell candidate to which to perform handover from the multiple cell candidates that meet the one or more conditions for performing handover based at least in part on one or more wireless device conditions; and
perform handover to the selected cell candidate.

2. The apparatus of claim 1,
wherein the one or more wireless device conditions include at least a jitter sensitive application or service based condition.

3. The apparatus of claim 2,
wherein the cell candidate to which to perform handover is selected further based at least in part on one or more of cell candidate duplexing configurations, slot durations, or downlink uplink transmission periodicities for each of the multiple cell candidates that meet the one or more conditions for performing handover based at least in part on the one or more wireless device conditions including at least a jitter sensitive application or service based condition.

4. The apparatus of claim 1,
wherein the one or more wireless device conditions include at least a dual subscriber identity module dual standby based condition.

5. The apparatus of claim 4, wherein the processor is further configured to cause the wireless device to:
determine a frequency combination for dual subscriber identity module dual standby operation for each of the multiple cell candidates that meet the one or more conditions for performing handover,
wherein the cell candidate to which to perform handover is selected further based at least in part on the frequency combinations for dual subscriber identity module dual standby operation for each of the multiple cell candidates that meet the one or more conditions for performing handover based at least in part on the one or more wireless device conditions including at least a dual subscriber identity module dual standby based condition.

6. The apparatus of claim 1,
wherein the one or more wireless device conditions include at least a wireless device speed based condition.

7. The apparatus of claim 6,
wherein the cell candidate to which to perform handover is selected further based at least in part on cell candidate operating frequencies for each of the multiple cell candidates that meet the one or more conditions for performing handover based at least in part on the one or more wireless device conditions including at least a wireless device speed based condition.

8. The apparatus of claim 1,
wherein the one or more wireless device conditions include at least an uplink performance based condition.

9. The apparatus of claim 8,
wherein the cell candidate to which to perform handover is selected further based at least in part on whether supplementary uplink is configured for each of the multiple cell candidates that meet the one or more conditions for performing handover based at least in part on the one or more wireless device conditions including at least an uplink performance based condition.

10. A wireless device, comprising:
an antenna;
a radio operably coupled to the antenna; and
a processor operably coupled to the radio;
wherein the wireless device is configured to:
receive conditional handover configuration information from a cellular base station, wherein the conditional handover configuration information indicates one or more conditions for performing handover and a plurality of cell candidates;
determine that multiple cell candidates meet the one or more conditions for performing handover;
select a cell candidate to which to perform handover from the multiple cell candidates that meet the one or more conditions for performing handover based at least in part on one or more wireless device conditions; and
perform handover to the selected cell candidate.

11. The wireless device of claim 10, wherein to select a cell candidate to which to perform handover, the wireless device is further configured to:
determine cell priority values for each of the cell candidates that meet the one or more conditions for performing handover for each of the one or more wireless device conditions, wherein the cell priority values are determined based at least in part on cell characteristics for the cell candidates that meet the one or more conditions for performing handover;
weight the cell priority values based at least in part on relative priority of the one or more wireless device conditions; and
determine an overall cell priority value for each of the plurality of cell candidates based at least in part on the weighted cell priority values,
wherein a cell candidate with a best overall cell priority value is selected as the cell candidate to which to perform handover.

12. The wireless device of claim 11,
wherein the overall cell priority value for each respective cell candidate of the plurality of cell candidates is determined by adding together the weighted cell priority values for the respective cell candidate for each of the one or more wireless device conditions.

13. The wireless device of claim 10,
wherein the one or more wireless device conditions include whether one or more jitter sensitive applications or services are active for the wireless device.

14. The wireless device of claim 10,
wherein the one or more wireless device conditions include whether the wireless device is operating in a dual subscriber identity module (SIM) dual standby mode.

15. The wireless device of claim 10,
wherein the one or more wireless device conditions include whether the wireless device is operating in a high speed mode.

16. The wireless device of claim 10,
wherein the one or more wireless device conditions include whether one or more uplink centric or uplink high reliability applications or services are active for the wireless device.

17. A method, comprising:
by a wireless device:
receiving conditional handover configuration information from a cellular base station, wherein the conditional handover configuration information indicates one or more conditions for performing handover and a plurality of cell candidates;
determining that multiple cell candidates meet the one or more conditions for performing handover;
prioritizing the multiple cell candidates that meet the one or more conditions for performing handover, wherein the multiple cell candidates that meet the one or more conditions for performing handover are prioritized based at least in part on cell characteristics for the multiple cell candidates that meet the one or more conditions for performing handover, wherein the cell characteristics used to prioritize the multiple cell candidates that meet the one or more conditions for performing handover are selected based on one or more wireless device conditions;
selecting a highest priority cell candidate among the multiple cell candidates that meet the one or more conditions for performing handover to which to perform handover; and
performing handover to the selected cell candidate.

18. The method of claim 17, wherein the method further comprises:
determining which wireless device conditions of a plurality of possible wireless device conditions are applicable for the conditional handover.

19. The method of claim 17, wherein the one or more wireless device conditions include one or more of:
a jitter reduction based condition;
a dual subscriber identity module dual standby based condition;
a wireless device speed based condition; or
an uplink performance based condition.

20. The method of claim 17, wherein the cell characteristics include one or more of:
cell duplexing configuration;
cell slot duration;
cell downlink uplink transmission periodicity;
cell frequency;
cell frequency band combination; or
cell supplementary uplink configuration.
